(19) United States
(12) Patent Application Publication
(10) Pub. No.: US 2023/0055936 A1
(43) Pub. Date: Feb. 23, 2023

(54) METHOD AND SYSTEM FOR WIRELESS CHARGING ALIGNMENT FOR VEHICLES

(71) Applicant: JINAN ZHENZHEN TECHNOLOGY RESEARCH INSTITUTE, Jinan, Shandong (CN)

(72) Inventor: Tingting ZHAO, BEIJING (CN)

(21) Appl. No.: 17/799,936

(22) PCT Filed: Feb. 17, 2021
(86) PCT No.: PCT/CN2021/076669

§ 371 Date: Aug. 16, 2022

(30) Foreign Application Priority Data
Feb. 17, 2020 (CN) 202010097802.4

(51) Int. Cl. B60L 53/38; B60L 53/12

(52) U.S. Cl. CPC B60L 53/38; B60L 53/12

(57) ABSTRACT

It relates to a sensor system (200) for wireless charging for vehicles (V) and a method for wireless charging alignment. The sensor system comprises (200): a sensor (201) for sensing positions of a wireless charging object (101) and one or more surrounding objects (102); a processor (202) for: determining a first relative position of the surrounding object (102) relative to the vehicle (V) (S401); selecting at least one surrounding object (102) as reference object and calculating a position reference between the reference object (102) and the wireless charging object (101)(S402); and, during a period when the sensor (201) does not sense the position of the wireless charging object (101), inferring a second relative position of the wireless charging object (101) relative to the vehicle (V), based on the calculated position reference and first relative position corresponding to the position reference (S403); wherein at least one first relative position is able to be used for anti-collision warning between the vehicle (V) and the corresponding surrounding objects (102), and wherein the second relative position is able to be used for the alignment of the vehicle (V) with the wireless charging object (102).

### TECHNICAL FIELD

The present disclosure relates to a method and system for wireless charging alignment for vehicles.

### BACKGROUND

As more and more vehicles are powered by electric energy, researches on wireless charging technology are becoming popular. For vehicles, the key point of wireless charging is how to perform the alignment between the wireless charging object installed on the ground and the vehicle (or the power receiver installed on the vehicle). Some technologies have been developed for wireless charging alignment for vehicles. For example, Jeffrey M. Alvesetc. have developed a wireless charging alignment system (U.S. Ser. No. 16/357,089A1), which relies on the vehicle's steering and propulsion control system to repeatedly move the vehicle according to the intensity of wireless charging transmission to align the vehicle with the wireless charging coil. Other technologies arrange dedicated sensors at the bottom of the vehicle to provide information about the relative position of the vehicle (receiving coil) and the wireless power transmitting device. However, most vehicles sold in the market do not provide high-level equipment.

Other technologies require additional communication/guidance systems, such as local communication systems for guiding vehicles. Other technologies rely on a dedicated reference object designed specifically for wireless charging alignment, such as a reference line extending from the wireless charging object to which a sensor of the vehicle can sense and thus to determine the location of the wireless charging object. These reference lines may be mixed up with the dividing lines for the parking cells. In addition, the use of additional dedicated reference objects may cause accumulation of errors and thus reduce the accuracy of alignment; dedicated reference objects may require additional construction and/or maintenance costs.

Therefore, an improved technical solution is needed.

### SUMMARY

Sensor systems such as auxiliary video systems and radar systems can detect targets near the vehicle that may collide with the vehicle. These sensor systems have been widely used in economical vehicles, such as reversing video system, reversing radar system and so on.

The advantage of the present disclosure provides that wireless charging alignment for vehicles may be provided based on these developed sensors, devices and/or existing production architectures. In particular, additional hardware/physical equipment dedicated to wireless alignment can be avoided.

The present disclosure provides a method for wireless charging alignment of a vehicle, the method comprising: during a first phase, sensing (for example, by using a sensor being capable of providing anti-collision warning) the positions for both a wireless charging object and surrounding objects near the vehicle parking area and calculating the positional relationship (or position mapping/position reference) between the wireless charging object and at least one surrounding object; during a second phase, sensing the position of the at least one surrounding object without sensing the position of the wireless charging object, and reversely inferring the position of the wireless charging object relative to the vehicle based on the calculated position relationship and the sensed position of at least one surrounding object.

It is advanced to use location references to infer the location of wireless charging objects. This is because the sensors used to detect objects that may collide with the vehicle are usually positioned toward the outside of the vehicle. However, as the vehicle moves above the wireless charging object during parking, the sensor may no longer be able to detect wireless charging object.

Therefore, another advantage of the present disclosure is that the wireless charging object can be sensed when it is “hidden” under the vehicle, even if the vehicle does install a sensor on the bottom of the vehicle. This allows saving (but not necessarily to save) bottom sensors that might be easily contaminated or damaged by splashes.

In addition, another advantage of the present disclosure is that by using surrounding objects (for example, potential obstacles) as a reference factor for inferring/determining the position of a wireless charging object, a dedicated reference object designed for wireless charging object sensing/positioning may be saved. In addition, compared to a smaller number of dedicated reference objects, the sampling to surrounding objects based on sensors provides more sufficient reference factors and therefore provides higher robustness.

In addition, by processing both obstacle sensing information (for collision warning) and wireless charging alignment information based on a single processing pipeline of the same sensor/sensor group/sensor module, the present disclosure may additionally provide at least the following advantages:

An embodiment of the present disclosure can use a single processing pipeline to generate an indication about whether the space allows the use of wireless charging objects. If an allowable distance indicated by the reference distance between the surrounding object (obstacle) and the wireless charging object is lower than a predetermined threshold distance, a message indicating that the space limited by the existing obstacle is not available for the wireless charging of the vehicle may be provided, wherein the threshold distance may be based on the distance from the wireless charging receiver to the edge of the vehicle. Compared with technologies using two separate processing pipelines for wireless charging alignment and anti-collision warning, this can provide the driver/autonomous driving vehicle with a notification of whether the wireless charging object is available under the current space conditions without the needing of interaction between different processing pipelines/systems.

For the type of wireless charging objects protruding from the ground surface, other technologies that use two separate processing pipelines for wireless charging alignment and collision warning may disadvantageously provide false collision warnings in connection with the wireless charging objects. In this regard, according to another embodiment of the present disclosure, the information representing the wireless charging object can be conveniently masked from the collision warning information as generated by the single processing pipeline, without the needing of interaction between different processing pipelines.

Another aspect of the present disclosure provides a sensor system. The sensor system comprises: a sensor for sensing position of a wireless charging object installed within a parking area of a vehicle and position of surrounding objects near the wireless charging object; a processor configured to: determine first relative positions of the surrounding objects relative to the vehicle; select at least one of the surrounding objects as a reference object, and calculate the position reference between the selected reference object and the wireless charging object; and infer a second relative position for the wireless charging object with respect to the vehicle based on the calculated position reference and at least one first relative position corresponding to the position reference during the period when the sensor does not sense the position of the wireless charging object. The processor is configured to be capable of providing the at least one first relative position for anti-collision warning, and capable of providing the second relative position for wireless charging alignment.

The present disclosure also provides a vehicle implementing the sensor system described herein.

The present disclosure also provides a machine-readable media encoded with instructions to implement the methods described herein.

### BRIEF DESCRIPTION OF THE DRAWINGS

Examples will now be described by way of non-limiting examples only with reference to the accompanying drawings. The accompanying drawings are not necessarily to scale. In the accompanying drawings:

FIGS. 1A and 1B show a scene where a vehicle is parked to a parking area according to an embodiment of the present disclosure;

FIG. 2 shows a sensor system 200 according to an embodiment of the present disclosure;

FIGS. 3A and 3B show a processing pipeline according to an embodiment of the present disclosure;

FIG. 4 shows a flowchart of a method according to an embodiment of the present disclosure; and

FIG. 5 shows a machine-readable medium according to an embodiment of the present disclosure.

### DETAILED DESCRIPTION

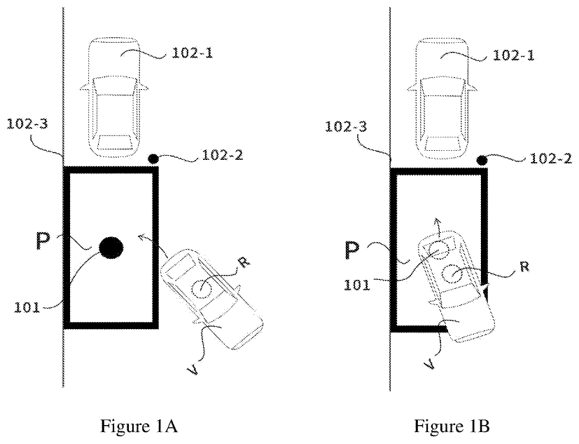

FIG. 1A shows the first stage during the parking of the vehicle to the parking area. As shown in FIG. 1, a vehicle V is about to park in the parking area P (as enclosed by the solid line). A wireless charging receiver R (indicated by the dashed line) is installed on the bottom of the vehicle V. A wireless charging object 101 is installed in the area P. As shown in FIG. 1, the first stage may refer to a period during which the sensor installed on the vehicle can detect both the wireless charging object 101 and the surrounding objects 102, or, a time period during which the vehicle does not move to “shade” the wireless charging object 101. The vehicle in FIGS. 1A and 1B is shown as a can, but it may also be other types of vehicles, such as motorcycle, boat, etc.

The wireless charging object 101 may be aligned with the wireless charging receiver R, and then transmit power to the vehicle V in a wireless manner. The wireless charging object 101 and the wireless charging receiver R in FIG. 1 are shown as circular, but they may have any shape. As an example, three surrounding objects 102 are shown in FIG. 1A: a surrounding object 1021 as a vehicle parked nearby, a surrounding object 1022 as a lamp post, and a surrounding object 1023 as a part of a wall. The surrounding objects may comprise potential obstacles around the parking area of the vehicle, for example, a road shoulder with a certain height, walls, lamp posts, and other vehicles near the parking area. It should be noted that the object does not necessarily have a specific shape or as a specific whole. An object can be regarded as the “surrounding object” described herein as long as it being within the sensing range of the onboard sensor and a regular position can be determined/detected for it.

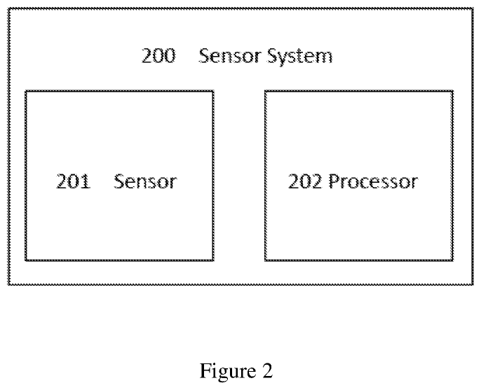

As shown in FIG. 2, the present invention provides a sensor system 200 that may be installed on a vehicle. The sensor system 200 comprises a sensor 201 and a processor 202.

The sensor 201 may comprises a single sensor or a group of sensors, which may be installed on the side of the vehicle and positioned toward outside of the vehicle. For example, it can be installed on one of the following: front bumper, rear bumper, air intake grille, front windshield, rear windshield, left side of the vehicle and right side of the vehicle. The sensor 201 may senses the position of objects (including wireless charging objects and surrounding objects near the parking area of the vehicle) relative to at least a part of the vehicle.

The sensor 201 may be a radar sensor. The “radar sensor” described herein means a sensor that senses/locates an object by transmitting pulses and receiving pulses reflected back from the object. The radar sensor can be implemented as lidar, millimeter wave radar, ultrasonic radar, or a combination thereof, but is not limited thereto.

The sensor 201 may also be an image sensor. In the case of an image sensor, the sensor 201 recognizes the position feature of the object relative to the vehicle based on image processing. The image-based sensor 201 may be a monocular image sensor, and calculate the position feature of the object based on multiple image frames captured at different time points (i.e., with the developed monocular 3D imaging technology).

The “processor 202” described herein may be a single processor with processing capability or a combination of multiple separated processing parts according to different processing functions. In an example, the first part of the processing elements constituting the processor 202 may be integrated with the electronic control unit (ECU) of the vehicle. The sensor 201 may be configured via the processor 202 to implement various functions/steps of the method disclosed herein.

In an embodiment, the sensor system 200 may comprise an object recognition engine for recognizing surrounding objects and/or wireless charging objects from the sensed objects.

The object recognition engine may be configured to recognize the wireless charging object 101 and/or surrounding objects 102 from a plurality of objects sensed by the sensor. For example, the sensor system 200 may be configured to recognize an object having a predefined characteristic as the wireless charging object 101. The predetermined features may comprise dimensional features, pattern features etc. Some institutions/organizations or manufacturers may specify the characteristics of the wireless charging object (wireless charging base), and such characteristics may be predefined in the sensor system 200. When the sensor system 200 is in operation, an object with the specified characteristic might be identified from the sensed objects as a wireless charging object. For example, if it is specified that the height of a wireless charging object used for a type C vehicle is h, the type C vehicle may recognize an object protruding from the ground at a height h as a wireless charging object. It should be noted that the features used for identification can comprise any type of features.

The object recognition engine may be configured to recognize wireless charging objects without predefined features, for example, a specific object can be selected as a wireless charging object from a captured/simulated image 101 based on user input (e.g., via a human-computer interaction interface).

The object recognition engine may comprise a switch for selecting whether the sensor system 200 is operated in a wireless charging alignment mode. When the wireless charging alignment mode is selected, the sensor 201 may identifies a wireless charging object 101 from a plurality of objects sensed.

The object recognition engine may be configured to recognize objects sensed/located in the general travel direction of the vehicle as surrounding objects 102. Preferably, an object located behind the identified wireless charging object 101 (i.e., an object farther from the vehicle than the wireless charging object 101 in the traveling direction) is recognized as the surrounding object 102. The traveling can refer to the forward movement of the vehicle or backward movement.

The position of the wireless charging object 101 relative to the surrounding object 102 (i.e., the position reference) may be calculated based on the position of the surrounding object 102 relative to the vehicle and the position of the wireless charging object 101 relative to the vehicle sensed at the same point in time. The surrounding objects used to calculate the position reference may be referred to as “reference object”. The position reference may be calculated when both the wireless charging object 101 and the surrounding objects 102 are visible to the sensor 201 (for example, during the first phase).

FIG. 1B shows the second stage of the vehicle parking to the parking area. During the second stage, the wireless charging object 101 is “hidden” under the vehicle due to the movement of the vehicle (so the wireless charging object in FIG. 1B is shown as dashed line), and therefore the sensor mounted on the vehicle does not sense the wireless charging object 101 but only senses at least one surrounding object 102 (or reference object).

As such, according to various embodiments of the present disclosure, after the vehicle V moves above the wireless charging object 101 (for example, during the second stage), the sensor may only sense/position the surrounding object 102 and no longer sense the wireless charging object 101. The processor may “reversely infer” the second relative position of the wireless charging object relative to the vehicle by referring to the first relative position between the object and the vehicle V and the calculated position reference.

The position reference described in the present disclosure may be a vector describing a measurement from the reference object to the wireless charging object in a coordinate system. During the first phase, the positions of both the reference object and the wireless charging object in the coordinate system can be detected, and the vector from the reference object to the wireless charging object can be calculated. During the second phase, the position of the reference object in the coordinate system can be detected, and this position may be shifted by the calculated vector in order to obtain the position of the wireless charging object in the coordinate system.

In an example, the coordinate system may be fixed with respect to the vehicle parking area. In this situation, the reference object, the wireless charging object and the vector representing the position reference between the reference object and the wireless charging object are constant in the coordinate system. In this case, the vehicle can calculate its position relative to the coordinate system, and provide information about the wireless charging alignment based on the position of the wireless charging object and vehicle's position in the coordinate system.

Table 1 shows the first and second stages involved in the method and sensor system of the present disclosure.

TABLE 1

| | objects of | | |
|---|---|---|---|
| | which | | |
| | position is | | |
| | sensed | processing | output |
| first | reference | the position of the | position reference |
| stage | object | reference object subtract | |
| | &wireless | the position of the | |
| | charging | wireless charging object | |
| | object | | |
| second | reference | the position of the | location of the |
| stage | object | reference object sum the | wireless charging |
| | | position reference vector | object |
| | | (translation by the | |
| | | position reference vector) | |

Wherein, the “position” in Table 1 may be the position of the reference object or the wireless charging object relative to the vehicle (or a specific part/point on the vehicle).

The wireless charging receiver R is usually fixed on the vehicle or connected to the vehicle via a mechanism whose movement can be measured. Therefore, it is possible to provide the driver or autonomous driving component of the vehicle with information indicating the relative position between the wireless charging receiver R and the wireless charging object 101 based on the “inferred” second relative position.

The sensing of the object and the calculation of the position reference (reference vector related to the position) herein may be implemented based on a model constructed by the points cloud. The density of the sampled points may depends on the sensor capability, processing capability, etc.

For simple sensors and/or processors, the sensed objects and calculated position references in this document may be implemented as signal statistics without constructing a model representing the spatial environment. “Feature point” can be sensed statistically based on the correlation of the transmitted and returned pulses with time. In an example, a correlation of two or more sets of feature points sensed in two or more directions (for example, by the so-called multipoint radar) can be extracted. Any of the objects represented by any certain points may be sensed in 3D manner based on the distances of multiple pulse transmitting and/or receiving points. In an example, it is possible to only account the feature points sensed by a single radar, and then compare multiple sets of feature points sensed by the single radar at different positions as the vehicle moves. An object is not necessarily an object as a whole that is represented by a successive of points, but just point features that can be obtained based on the analysis on the returned signal for representing an object.

Therefore, the reference object herein may be based on a set of sensed points, but not necessarily a whole object having certain shape obtained based on point cloud analysis. And therefore, the calculated location reference herein may be a vector representing the location that is generated based on both the statistical characteristics of the returned signal and the statistical characteristics designated as the wireless charging object.

In an embodiment, the sensor system 200 may comprise a reference object selection engine for selecting the surrounding object among the surrounding objects sensed by the sensor system as a reference object according to a predefined specification.

The reference object selection engine may use the surrounding objects closest to the vehicle (or the area where it will be parked) in the traveling direction of the vehicle as the reference object for calculating the position reference, and provide collision warning information based on the closest reference object. This can reduce the calculation amount of the sensor 201.

The reference object selection engine may calculate multiple position references for multiple reference objects, and then calculate multiple wireless charging object positions (or multiple second relative positions for the wireless charging object relative to the vehicle) based on the multiple position references. Compared with considering only one reference object, the position of a wireless charging object (inferred position) can be inferred in a more accurate manner based on the inferred positions in relation to multiple reference objects, such as: an inferred position farther from the other inferred positions can be reject; and calculate the average of the multiple inferred positions to obtain the final inferred position, and the like.

The reference object selection engine may also eliminate the mutated surrounding objects to improve the robustness of the inference process. For example, one surrounding object used to calculate the position reference may be a neighboring vehicle that drives away (i.e., mutation) during the inference process. In this case, a stable position inference of the wireless charging object 101 can be obtained based on the position reference related to the remaining surrounding objects without mutation.

The sensor system 200 may be configured to: provide a message to the driver to instruct the driver to manually place an object when the sensor system cannot recognize surrounding objects that can be used as a reference object. For example, if the vehicle was to park in a parking space with no reference object around it, the system may not be able to detect a suitable reference object. In this case, a voice or display message such as “please place a reference object” may be provided.

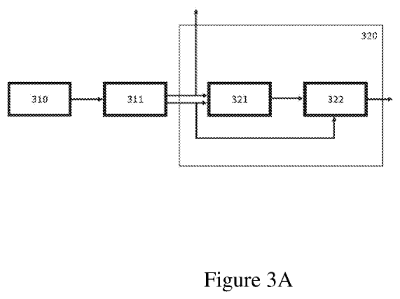

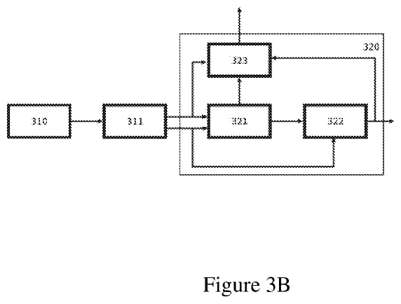

FIGS. 3A and 3B show a processing pipeline according to an embodiment of the method and sensor system of the present disclosure.

As shown in FIG. 3A, a processing pipeline 31 may comprise a sensor module 310 capable of sensing the position of objects. The processing pipeline 31 may further comprise an object recognition module 311 capable of recognizing a wireless charging object and surrounding objects from a plurality of objects sensed by the sensor module 310. The object recognition module 311 may send wireless charging object information and surrounding object information (each object information may comprise information describing the position of the object relative to the vehicle) to the position reference calculation engine 321 of the processing module 320. The position reference calculation engine 321 may calculate a position reference (or a reference vector associated with the position) that represents the position relationship between at least one surrounding object and the wireless charging object. In addition, surrounding object information can be sent to the inference engine 322 of the processing module, as shown in FIG. 3A. The inference engine 322 uses the received surrounding object information and the position reference from the position reference calculation engine 321 to infer the position of the wireless charging object. The inference engine 322 can output the inferred position of the wireless charging object for wireless charging object alignment for the vehicle.

Any module or engine described together with the “processing pipeline” herein may correspond to the steps described with reference to the method and the sensor or processor described with reference to the sensor “system”. For example, the sensor of the sensor system herein can be implemented as a sensor module described with reference to the processing pipeline, and the processor of the sensor system herein can be implemented as a processing module 320 including the object recognition module 311, the position reference calculation engine 321 and the inference engine 322.

The processing pipeline 32 shown in FIG. 3B may generally comprise all elements of the processor pipeline 31. Additionally, the processing module of the processing pipeline 32 also comprises an additional processing engine 323.

The additional processing engine 323 may, for example, be configured to shield the wireless charging object 101 in the process of providing anti-collision warning information. By outputting the masked information to provide anti-collision warning, the message about anti-collision warning can advantageously eliminate “false” alarms. For example, a sensor that only provides anti-collision warning may be oriented to only detect objects higher than a certain height (or to filter objects below a certain height when providing position information of the objects). Compared with a sensor that only provides anti-collision warning, at least one sensor of the disclosed sensor system that can be used for wireless charging alignment might be positioned lower to detect a wireless charging object being designed lower than the height of the vehicle chassis. The additional processing engine 323 configured to shield the wireless charging object 101 may filter the position information representing the wireless charging object 101 from the information for providing anti-collision warning based on the results of the position reference calculation engine 321 or the inference engine 322. This advantageously provides both a clear anti-collision warning information and wireless charging alignment information at the same time.

In an embodiment, if an allowable distance indicated by the reference distance between the surrounding object (an obstacle for example) and the wireless charging object was lower than a predetermined threshold distance, an message can be provided to indicate that the space defined by the current obstacle is not available for the vehicle to alignment with the wireless charging object, or, if continue to alignment, a collision may occur, wherein the threshold distance may be based on the distance from the wireless charging receiver to the edge of the vehicle.

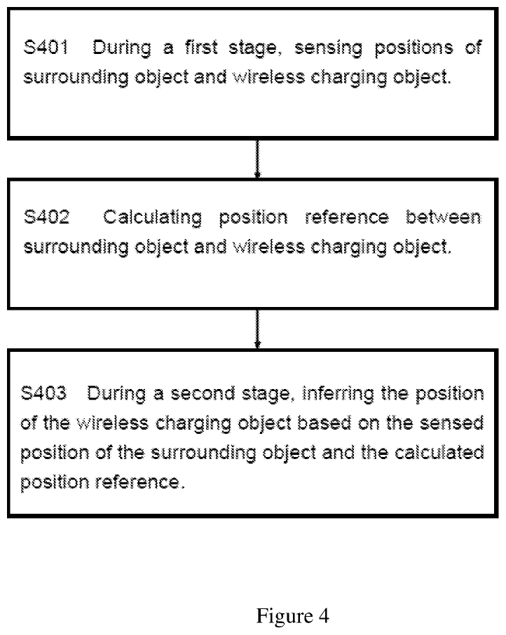

FIG. 4 shows a flowchart of a method according to the present disclosure. At S401, during the first stage, the position of the surrounding object and the position of the wireless charging object are sensed. At S402, a position reference between surrounding objects and wireless charging objects is calculated. At S403, during the second phase, the position of the wireless charging object is inferred based on the sensed position of the surrounding object and the calculated position reference.

According to the present disclosure, a non-transitory machine-readable medium may store instructions, which when executed by a processor, cause the processor to perform any embodiment of the method of the present disclosure.

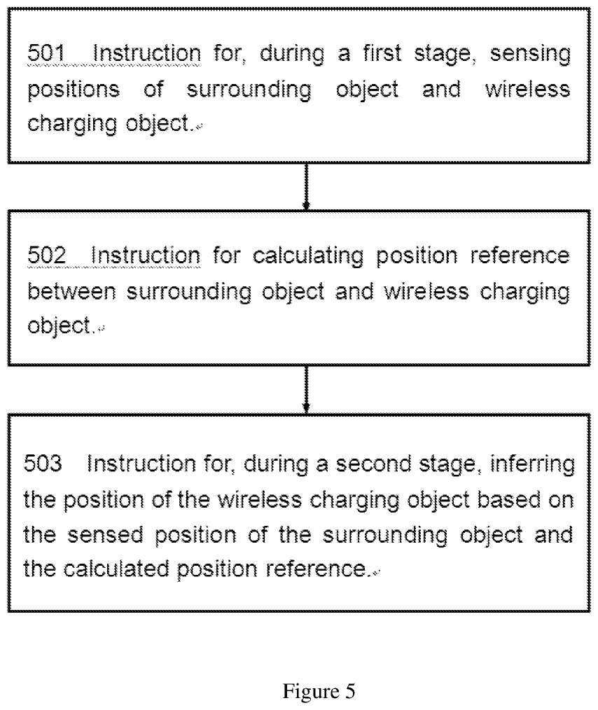

FIG. 5 shows by way of example a machine-readable medium according to an embodiment of the present disclosure, including: instruction 501 for a processor to sense the position of the surrounding objects and the position of the wireless charging object during the first stage; instruction 502 for the processor to calculate the position reference between the surrounding object and the wireless charging object; an instruction 503 that causes the processor to infer the position of the wireless charging object according to the sensed position of the surrounding object and the calculated position reference during the second stage.

Those skilled in the art should notes that various modifications, changes, omissions and substitutions can be made without departing from the spirit of the present disclosure, and are not limited to the method, systemand related aspects that have been described with reference to certain examples/embodiments/drawings. Besides, those skilled in the art will be able to design many alternative embodiments without departing from the scope of the appended claims. Features described with respect to one example can be combined with features of another example.

1. A sensor system for wireless charging for a vehicle, the sensor system comprising:
a sensor for sensing position of a wireless charging object installed within a parking area of the vehicle and position of surrounding objects near the wireless charging object;
a processor configured to:
determining a first relative position of the surrounding objects relative to the vehicle;
selecting at least one surrounding object among the surrounding objects as a reference object, and calculating a position reference between the reference object and the wireless charging object; and
during a period when the sensor does not sense the position of the wireless charging object, inferring a second relative position of the wireless charging object relative to the vehicle, based on the calculated position reference and at least one first relative position corresponding to the position reference;
wherein at least one of the first relative position is able to be used for anti-collision warning between the vehicle and the corresponding surrounding objects, and wherein the second relative position is able to be used for the alignment of the vehicle with the wireless charging object.

2. The sensor system of claim 1, the processor is further configured to compare a distance associated with the position reference with at least one charging threshold distance to indicate whether a wireless charging receiver installed on the vehicle is able to be aligned with the wireless charging object without the a colliding of the vehicle with the at least one surrounding object,
wherein the charging threshold distance represents a distance from the wireless charging receiver to an edge of the vehicle.

3. The sensor system of claim 1, wherein the sensor comprises a radar sensor that locates objects by transmitting and receiving pulses.

4. The sensor system according to claim 3, wherein the sensor system is configured to recognize object having a predetermined characteristic as the wireless charging object.

5. The sensor system according to claim 4, wherein the sensor system is configured to recognize the wireless charging object from a plurality of objects, and to shield the wireless charging object in a process for providing an anti-collision warning, such that the provided anti-collision warning message does not include an anti-collision warning message provided for the wireless charging object.

6. The sensor system of claim 1, wherein the sensor comprises a vision sensor that locates objects based on an image.

7. A vehicle comprising the sensor system according to any one of claims 1 to 6.

8. A method for wireless charging alignment for a vehicle, the method comprising:
during a first stage in which both surrounding objects near a parking area of the vehicle and a wireless charging object installed within the parking area are within sensing range of a sensor, using the sensor to sense position of the surrounding objects and position of the wireless charging object;
calculating a position reference between at least one of the surrounding objects and the wireless charging object; and
during a second stage in which the wireless charging object is not detectable by the sensor, reversely inferring the position of the wireless charging object based on the sensed position of the at least one surrounding object and the calculated position reference.

9. The method of claim 8, further comprising comparing a distance associated with the position reference with a distance from a wireless charging receiver installed on the vehicle to an edge of the vehicle, to indicate whether a distance from the wireless charging object to the at least one surrounding object is sufficient for wireless charging without collision.

10. The method according to claim 8, further comprising identifying the wireless charging object from a plurality of objects, and shielding the wireless charging object in a process for providing anti-collision warning, such that a provided anti-collision warning message does not include an anti-collision warning message provided for the wireless charging object.

11. A non-transitory machine-readable medium storing instructions that, when executed by a processor, cause the processor to perform the method according to any one of claims 8 to 10.
